(19) United States
(12) Patent Application Publication
(10) Pub. No.: US 2016/0348618 A1
(43) Pub. Date: Dec. 1, 2016

(54) Intake Air Sensor and Sensing Method for Determining Air Filter Performance, Barometric Pressure, and Manifold Pressure of a Combustion Engine

(71) Applicant: Amphenol Thermometrics, Inc., Saint Marys, PA (US)

(72) Inventors: Jason J. Detsch, St. Marys, PA (US); Brian Engle, Deltona, FL (US); David A. Villella, St. Marys, PA (US)

(21) Appl. No.: 14/721,537

(22) Filed: May 26, 2015

(51) Int. Cl. F02M 35/10; F02M 35/104; G01N 15/08; F02M 35/024

(52) U.S. Cl. CPC F02M 35/1038; F02M 35/024; F02M 35/104; F02M 35/10249; G01N 15/0806; G01N 2015/084

(57) ABSTRACT

A sensor for sensing a differential pressure across an air filter in a motor vehicle. The sensor includes a sensor body having a first air passageway communicating with an atmosphere and a second air passageway communicating with an interior cavity of a manifold of a combustion engine. The sensor further includes a differential pressure sensor disposed within the sensor body and a microcontroller. The differential pressure sensor is coupled to the first air passageway and to the second air passageway. The differential pressure sensor is configured to measure a differential pressure between the atmosphere communicated to the differential pressure sensor via the first air passageway and the interior cavity of the manifold communicated to the differential pressure sensor via the second air passageway. The microcontroller is configured to receive the measured differential pressure from the differential pressure sensor. The microcontroller outputs an indication of how dirty the air filter is.

### FIELD OF THE INVENTION

The present invention relates to a method and system for measuring properties of air within an intake system of an internal combustion engine and proximal to an intake plenum opening and air filter, which properties include any of absolute pressure, temperature, and humidity desirable for accurate combustion control, and, more specifically, to a method and system for sensing a pressure drop across a filter used in the motor vehicle to determine whether the filter should be replaced as it becomes plugged through accumulation of dust and debris. The increased pressure drop across the air filter impacts engine performance and emissions control and can lead to damage of engine hardware, including turbochargers, as well as failure to meet emissions performance requirements.

### BACKGROUND OF THE INVENTION

Referring to FIG. 6, there is illustrated a conventional system 600 for calculating a pressure drop across an air filter in a motor vehicle 610, such as a truck, car, tractor, motorcycle, or the like. The motor vehicle 610 comprises an air filter 618 and a passageway 630. In one exemplary embodiment, the passageway 630 is an intake manifold to an engine of the motor vehicle 610. In another exemplary embodiment, the passageway 630 is an inlet into a turbo charger in the motor vehicle 610. For purposes of discussion herein, the passageway 630 is assumed to be a manifold. It is to be understood that the passageway 630 is not limited to being a manifold but may be an inlet to a turbocharger in relevant embodiments of the system 600.

The manifold 630 is formed by two side walls 612 and 614, which as shown can be arranged spaced apart and opposite one another. The air filter 618 extends from one wall 612 to the other wall 614 and is positioned at an intake end of the manifold 630. As known in the art, the air filter 618 filters air passing in a direction A through the filter 618 and the manifold 630 before entering the engine or turbo charger. The manifold 630 and air filter 618 of the motor vehicle 610 are illustrated in FIG. 6 in cross section.

As the filter 618 becomes dirty, the volume of air passing through the filter 618 drops, thereby reducing performance of the engine of the motor vehicle 610. Accordingly, the conventional system 600 monitors the absolute air pressure in the manifold 630 and compares this value to a separate barometric pressure sensor to determine how dirty the air filter 618 is. Specifically, the conventional system 600 calculates a pressure drop across the air filter 618 to determine how dirty the air filter 618 is. To this end, the conventional system 600 further comprises an air pressure sensor system 640.

The air pressure sensor system 640 comprises a sensor 650 having a sensor body 655 containing a manifold absolute pressure (MAP) sensor 660 and a microcontroller 670. The manifold absolute pressure sensor 660 is in air communication with the manifold 630 via an air passage 662 which opens to the manifold 630 via a vent 664 in the wall of the sensor body 655. The sensor 650 is mounted in an opening in the wall 612 of the inlet 630 (i.e., the manifold 630) and is sealed by a seal 616, such as a rubber gasket or the like, that is positioned between the sensor body 655 and the wall 612.

The air pressure system 640 further comprises an engine control unit (“ECU”) 680, which is mounted in the motor vehicle 610, and a barometric pressure sensor 690, which may be mounted either on the ECU 680 or remotely from the ECU 680, such as within the cabin of the vehicle 610.

The manifold absolute pressure sensor 660 measures an absolute pressure in the manifold 630 that is present at the air passage 662. The manifold absolute pressure sensor 660 transmits the measured absolute pressure (also referred to herein as “manifold absolute pressure” or “MAP”) to the microcontroller 670 via signal/communication lines 665. The microcontroller 670 forwards the MAP to a communication network 681 in the motor vehicle 610 via signal/communication lines 675, and the communication network 681 forwards the MAP to the ECU 680 via signal/communication lines 685.

The barometric pressure sensor 690 measures an absolute barometric pressure of the environment in which the engine 610 is operating. It transmits the measured barometric pressure (also referred to herein as “BP”) to the ECU 680 via signal/communication lines 695.

The ECU 680 receives the MAP from the microcontroller 670 and the BP from the barometric pressure sensor 690. The ECU 680 subtracts MAP from BP to determine the pressure drop, ΔP (also referred to herein as “differential pressure”), across the filter 618:

ΔP₁₌BP−MAP (1)

The ECU 680 provides an indication of the pressure drop, ΔP, across the air filter 618. If the pressure drop, ΔP, is below a first threshold amount, the ECU 680 provides an indication that the air filter 618 is clean. If the pressure drop is below a second threshold amount but equal to or greater than the first threshold amount, the ECU 680 provides an indication that the air filter 618 is dirty. If the pressure drop is below a third threshold amount but equal to or greater than the second threshold amount, the ECU 680 could take remedial action, such as to lower the power of the engine of the motor vehicle 610 to reduce the amount of air that it consumes to avoid damaging the engine. If the pressure drop is below a fourth threshold amount but equal to or greater than the third threshold amount, the ECU 680 could take further remedial action to avoid damaging the engine, such as to lower the torque produced by the engine and/or provide an indication that the filter 618 must be replaced.

### SUMMARY OF THE INVENTION

In accordance with an aspect of the present invention, there is provided a sensor for directly measuring a differential pressure across an air filter in a combustion engine. The sensor includes a sensor body comprising a first air passageway communicating with atmosphere and a second air passageway communicating with an interior cavity of an air induction system for the combustion engine. The sensor further comprises a differential pressure sensor disposed within the sensor body. The differential pressure sensor is coupled to the first air passageway and to the second air passageway. The differential pressure sensor is configured to measure a differential pressure between the atmosphere communicated to the differential pressure sensor via the first air passageway and the interior cavity of the air induction system communicated to the differential pressure sensor via the second air passageway. The sensor is designed with a range of only 15 kPa and an accuracy of 2%, resulting in measurement errors of within +/−0.3 kPa. The sensor may further include a microcontroller that is configured to receive the measured differential pressure from the differential pressure sensor. The microcontroller outputs an indication of how dirty the air filter is based on the measured differential pressure.

In accordance with another aspect of the present invention, there is provided a sensor system for sensing a differential pressure across an air filter in a combustion engine. The sensor system comprises a sensor, a microcontroller, a communications bus, and an engine control unit. The sensor comprises a sensor body comprising a first air passageway communicating with atmosphere, a second air passageway communicating with an interior cavity of an air induction system of the internal combustion engine, and a differential pressure sensor disposed within the sensor body. The differential pressure sensor is coupled to the first air passageway and to the second air passageway. The differential pressure sensor is configured to measure a differential pressure between the atmosphere communicated to the differential pressure sensor via the first air passageway and the interior cavity of the air induction system communicated to the differential pressure sensor via the second air passageway. The microcontroller is configured to receive the measured differential pressure from the differential pressure sensor. The engine control unit of the internal combustion engine is coupled to the communications bus and is in communication with the sensor via the communications bus. The microcontroller further comprises an output for transmitting the measured differential pressure to the engine control unit via the communications bus. The engine control unit outputs an indication of how dirty the air filter is based on the measured differential pressure.

In accordance with yet another aspect of the present invention, there is provided a method for sensing differential pressure. The method comprises a step of sensing a differential pressure, using a gauge pressure sensor of a sensor, across an intake filter of an air induction system of an internal combustion engine. The manifold comprises an interior cavity. The vehicle sensor comprises the gauge pressure sensor and a microcontroller. The method further comprises a step of outputting the sensed differential pressure value to the microcontroller. In an exemplary embodiment, an indication of whether the intake filter is dirty is provided.

### BRIEF DESCRIPTION OF THE DRAWINGS

For the purpose of illustration, there are shown in the drawings certain embodiments of the present invention. In the drawings, like numerals indicate like elements throughout. It should be understood that the invention is not limited to the precise arrangements, dimensions, and instruments shown. In the drawings:

FIG. 1A illustrates a side view of a sensor, in accordance with an exemplary embodiment of the present invention;

FIG. 1B illustrates a front view of the sensor of FIG. 1A, in accordance with an exemplary embodiment of the present invention;

FIG. 2 illustrates a cross-sectional view of the sensor of FIG. 1A, in accordance with an exemplary embodiment of the present invention;

FIG. 3 illustrates a cross-sectional view of another embodiment of the sensor of FIG. 1A, in accordance with an exemplary embodiment of the present invention;

FIG. 4 illustrates a system for sensing a pressure drop across an air filter in an air induction system for an internal combustion engine, in accordance with an exemplary embodiment of the present invention;

FIG. 5A illustrates a first method for sensing a pressure drop across an air filter in an air induction system for an internal combustion engine, in accordance with an exemplary embodiment of the present invention;

FIG. 5B illustrates a second method for sensing a pressure drop across an air filter in an air induction system for an internal combustion engine, in accordance with an exemplary embodiment of the present invention; and

FIG. 6 illustrates a conventional system for calculating a pressure drop across an air filter in a motor vehicle.

### DETAILED DESCRIPTION OF THE INVENTION

Reference to the drawings illustrating various views of exemplary embodiments of the present invention is now made. In the drawings and the description of the drawings herein, certain terminology is used for convenience only and is not to be taken as limiting the embodiments of the present invention. Furthermore, in the drawings and the description below, like numerals indicate like elements throughout.

In the conventional system 600, the BP sensor 690 will typically register pressures from about 15 kPa to 120 kPa. The value for measured BP has an accuracy error of about 2% to 3% of full scale pressure and deteriorates with typical extreme temperatures seen in the internal combustion engine of the motor vehicle 610, typically from −40 C to 125 C within the engine enclosure. The resultant error is +/−2.5 kPa throughout the operational range. Therefore, the wide pressure range of the BP sensor 690 dilutes its accuracy.

In the conventional system 600, the MAP sensor 660 typically registers pressures from about 10 kPa to 350 kPa. The value for measured MAP has an accuracy error of about 2%. The resultant error is +/−6.8 kPa. Therefore, the wide pressure range of the MAP sensor 660 dilutes its accuracy.

The sensor 690 may be located in an air-conditioned cab of the motor vehicle 610. Air conditioning in the cab may provide a positive cabin pressure, which adds an unwanted offset, n, to the BP measurement. The calculated differential pressure becomes:

ΔP₂=BP+n−MAP (2)

If n amounts to 1-3 kPa (e.g., about 2% error), the problem of erroneous indications of when the filter is clean or dirty because of the inherent errors in BP and MAP are compounded.

Because both the MAP sensor 660 and the BP sensor 690 contribute error, the resultant error in accuracy of the calculated pressure drop, ΔP, is within +/−9.3 kPa, with a best case error in accuracy within +/−4.3 kPa. Such error is undesirable because the pressure drop across the air filter 618 that can cause issues in engine control can be as low as 5-6 kPa, and the stack-up of errors from the two broad range pressure sensors 660, 690 often can result in false positive faults and false negative indications of a plugged air filter 618. Stated another way, the calculated difference between BP and MAP has a low signal-to-noise ratio and therefore can be unreliable. The implications of a false negative indication can be loss of emissions control and possible damage to sensitive engine components. Accessing the air filter 618 to replace it when not needed is wasteful and time consuming, especially if the air filter 618 is difficult to access. The implications of false positive indication of a plugged air filter 618 are more machine downtime and unneeded replacements of the air filter 618.

In accordance with exemplary embodiments of the present invention, there are provided methods and systems for measuring properties of air within an intake system of an internal combustion engine (e.g., of a vehicle) and proximate to an intake plenum opening of the internal combustion engine. Knowledge of these properties is desirable to estimate relative mass of H₂O, CO₂ (which limits combustion), and O₂ for controlling a combustion process in the motor vehicle. Optimizing the combustion process in the engine involves maximizing engine output and minimizing emissions.

An important constituent of an internal combustion engine's intake system is its intake air filtration system. In accordance with exemplary embodiments of the present invention, there are provided methods and systems for monitoring system properties and performance of an internal combustion engine to determine the monitored properties of its intake air filtration system for diagnostics, including a determination of when an air filter of the air filtration system is desirably replaced. Monitored properties include intake air temperature, humidity, intake air pressure, carbon dioxide concentration, and absolute ambient air pressure and temperature proximate to an intake air plenum of a combustions system of the internal combustion engine.

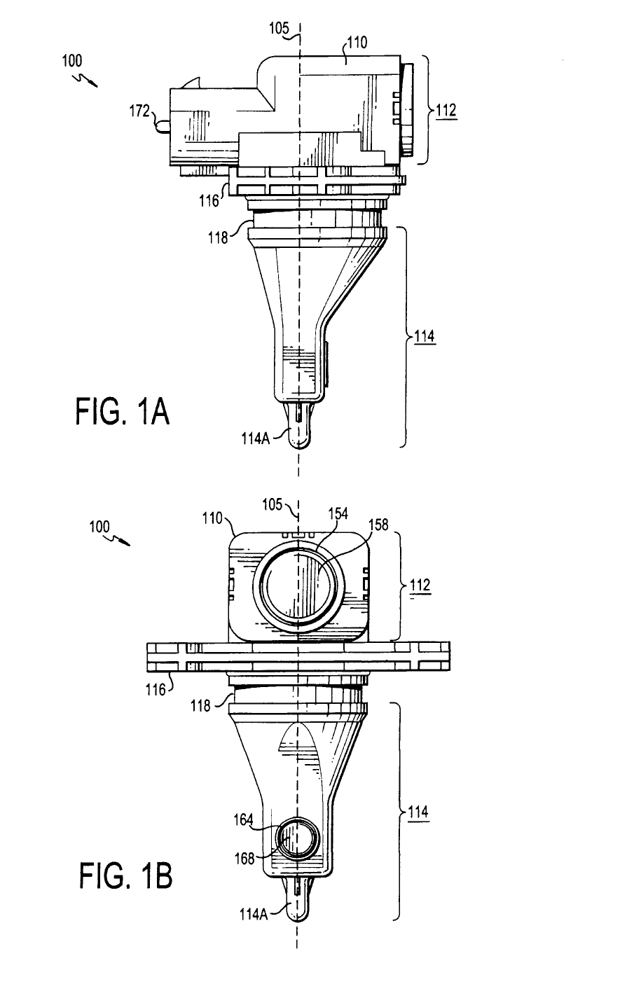

Illustrated in FIG. 1A is a side view of an exemplary embodiment of a sensor, generally designated as 100, in accordance with an exemplary embodiment of the present invention. Illustrated in FIG. 1B is a front view of the sensor 100, in accordance with an exemplary embodiment of the present invention. Referring to FIGS. 1A and 1B together, the sensor 100 comprises a body 110 having a top enclosure 112, a bottom probe body 114, a mounting flange 116, and a circumferential groove 118 providing a seal area. The mounting flange 116 and the circumferential groove 118 are disposed between the top enclosure 112 and the bottom probe body 114 and separate the top enclosure 112 from the bottom probe body 114. The bottom probe body 114 extends downward along a longitudinal axis 105 of the sensor 100. A bottom of the bottom probe body 114 is a thermal probe enclosure 114A.

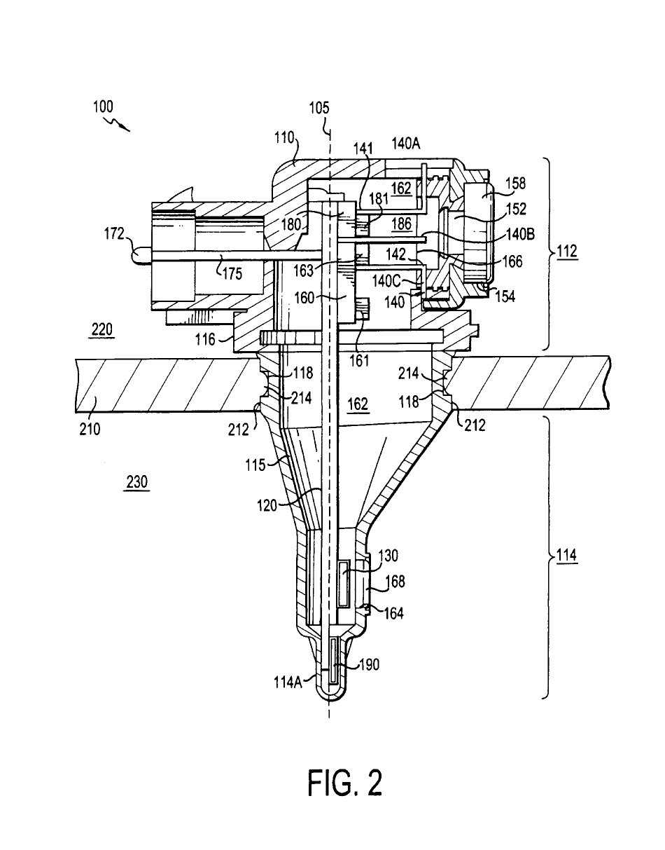

Disposed within the top enclosure 112 is a vent port 154, which opens to a top internal communication passage 152 (described in further detail below with respect to FIG. 2) within the top enclosure 112. In the exemplary embodiment illustrated in FIG. 1B, the vent port 154 is protected by a membrane 158, which provides for the free passage of air while preventing dust and dirt from entering the vent port 154. It is contemplated that the membrane 158 may be hydrophobic. It is to be understood that in other exemplary embodiments other types of membranes 158 may be used.

Disposed within the bottom probe body 114 is a communication port 164, which opens to a bottom internal communication passage 162 (described in further detail below with respect to FIG. 2) within the bottom probe body 114. In the exemplary embodiment illustrated in FIG. 1B, the manifold communication port 164 is protected by a membrane 168, which provides for the free passage of air while preventing dust and dirt from entering the communication port 164. It is contemplated that the membrane 168 may be hydrophobic. It is to be understood that in other exemplary embodiments other types of membranes 168 may be used.

Also disposed within the top enclosure 112 is an electrical connector 172. The electrical connector 172 provides for electrical communication of sensor signals generated by sensors of the sensor 100.

Referring now to FIG. 2, there is illustrated a cross sectional view of the sensor 100, in accordance with an exemplary embodiment of the present invention. The sensor 100 is illustrated as being disposed across a wall 210 for sensing a pressure drop (also referred to herein as “differential pressure”) across the wall 210. The sensor 100 is positioned such that its longitudinal axis 105 is perpendicular to the wall 210.

The wall 210 separates a first air space 220 from a second air space 230. In an exemplary embodiment, the first air space 220 is atmosphere and the second air space 230 is an air space other than atmosphere, such as an intake manifold to an internal combustion engine (e.g., of a motor vehicle) or an intake to a turbocharger (e.g., of a motor vehicle).

The sensor 100, specifically the circumferential groove 118 thereof, is illustrated as being disposed in an opening 212 in the wall 210. Disposed in the opening 212 between the circumferential groove 118 of the sensor 100 and the opening 212 is a seal 214. The seal 214 provides an air-tight seal between the circumferential groove 118 of the sensor 100 and the opening 212 in the wall 210.

The sensor 100 comprises an interior space 115 and a circuit board 120 disposed in the interior space 115 along the longitudinal axis 105 of the sensor 100 from the top of the interior space 115 in the top enclosure 112 to the bottom of the interior space 115 in the thermal probe enclosure 114A. Disposed on the circuit board 120 are a gauge pressure sensor 160 and an absolute pressure sensor 180.

The gauge pressure sensor 160 comprises a first port 161, which communicates with the internal communication passage (a first air passage) 162, which is disposed within the body 110. Thus, the first port 161 of the gauge pressure sensor 160 is in air flow communication with the second air space 230 via the first air passage 162 which opens to the second air space 230 via the port 164 in the sensor body 110.

The gauge pressure sensor 160 further comprises a second port 163, which communicates with a second air passage 166, which is disposed within the body 110. The second air passage 166 communicates with a third air passage (an internal communication air passage) 152, which is also disposed within the body 110 and which opens to the atmosphere 220 via the port 154 in the wall of the body 110. Thus, the second port 163 of the gauge pressure sensor 160 is in air flow communication with the atmosphere 220 via the second air passage 166 and the third air passage 152.

The absolute pressure sensor 180 comprises a port 181, which communicates with a fourth air passage 186, which is disposed within the body 110. The fourth air passage 186 communicates with the third air passage 152. Thus, the port 181 of the absolute pressure sensor 180 is in air flow communication with the atmosphere 220 via the fourth air passage 186 and the third air passage 152, which opens to the atmosphere 220 via the port 154 in the wall of the body 110.

The sensor 100 further comprises a port seal 140, which comprises a first portion 140A at top, a second portion 140B in the middle, and a third portion 140C at bottom. The port seal 140 separates the interior space 115 into the air passages 162, 166, 152, and 186. Furthermore, the port seal 140 isolates the first air passage 162 from the air passages 166, 152, and 186. Specifically, the first and third portions 140A, 140C of the seal 140 separate the interior space 115 to form the first air passage 162 and to isolate it from the air passages 166, 152, and 186. The first and third portions 140A, 140C appear as L-shaped sections in FIG. 2 because FIG. 2 illustrates a cross section of the sensor 100 and, hence, of the port seal 140. It is to be understood that the portions 140A and 140C illustrate sections of an outer wall of the port seal 140. This outer wall is formed as a unitary cylindrical wall portion 141 and a unitary flange portion 142.

The second (middle) portion 140B of the port seal 140 separates the second air passage 166 from the fourth air passage 186, but it does not isolate the air passages 166 and 186 from one another. As seen in FIG. 2, the second air passage 166 is disposed in the port seal 140 between the second and third portions 140B and 140C, and the fourth air passage 186 is disposed in the port seal 140 between the first and second portions 140A and 140B. The air passages 166 and 186 are joined together by the third air passage 152, which opens to the first air space 220 at the vent port 154. Other exemplary embodiments of the port seal 140 in which the middle portion 140B is omitted are contemplated, in which embodiments the air passages 166 and 186 are merged. Finally, the third air passage 152 is disposed between the flange portion 142 of the port seal 140 and the vent port 154. The third air passage 152 is separated and isolated from the first air passage 162 by the port seal 140.

In an exemplary embodiment, the sensor 100 further comprises means for sensing temperature. In one alternative of this embodiment, the means for sensing temperature may comprise a temperature sensor 190 disposed on the circuit board 120 at the bottom of the sensor body 110 in the thermal probe enclosure 114A of the bottom probe body 114. The temperature sensor 190 measures an ambient temperature within the second air space 230. In another alternative of this embodiment, the means for sensing temperature may comprise a temperature sensor 130 disposed on the circuit board 120 adjacent to the vent port 164. The temperature sensor 130 measures temperature of air in the second air space 230 entering the vent port 164. In yet another alternative of this embodiment, the means for sensing temperature may comprise both the temperature sensor 130 and the temperature sensor 190. In still yet another exemplary embodiment, the means for sensing temperature may also or alternatively comprise temperature sensing capabilities in either or both of the sensors 160 and 180. In such an embodiment, the sensor 180 further measures temperature of air, via the port 181, from the first air space 220 that enters the vent port 154, and the sensor 160 further measures temperature of air, via the port 161, from the second air space 230 that enters the vent port 164 and/or temperature of air, via the port 163, from the first air space 220.

In another exemplary embodiment, the sensor 100 further comprises means for sensing temperature and humidity. The means for sensing temperature and humidity may comprise a temperature and humidity sensor 130 disposed on the circuit board 120 adjacent to the vent port 164. The temperature and humidity sensor 130 measures temperature and humidity of air in the second air space 230 entering the vent port 164. In an alternative of this embodiment, the means for sensing temperature and humidity comprises both the temperature and humidity sensor 130 and the temperature sensor 190.

The sensors 160, 180 and optional sensors 130 and 190 are physically mounted on the circuit board 120 and are connected to the electrical connector 172 via wire traces on the circuit board 120 and signal/communication lines 175 for communicating their sensor signals to external devices. The electrical connector 172 extends from the first air space 220 to the interior space 115 and is sealed against the body 110 of the sensor 110 to prevent air communication between the first air space 220 and the interior space 115 other than through the vent port 154.

The gauge pressure sensor 160 directly detects the pressure drop, ΔP₃ (also referred to herein as “differential pressure”), across the wall 210. Specifically, it measures a difference between (1) the pressure in the second air space 230 communicated to the gauge pressure sensor 160 through the port 161 via the first air passage 162 and (2) the pressure in the first air space 220 communicated to the gauge pressure sensor 160 through the port 163 via the second and third air passages 166 and 152. The gauge pressure sensor 160 outputs the measured differential pressure between the pressure in the second air space 230 and the pressure in the first air space 220, which difference is equal to the pressure drop across the wall 210. The gauge pressure sensor 160 transmits the measured pressure drop to the electrical connector 172 via signal/communication lines 175.

The absolute pressure sensor 180 measures the absolute pressure (also referred to herein as “barometric pressure” or “BP”) of the first air space 220. The absolute pressure sensor 180 transmits the measured BP to the electrical connector 172 via signal/communication lines 175.

Because both of the air passages 166 and 186 communicate with the atmosphere 220 via the air passage 152, the air passage 152 is a common air passage for both the gauge pressure sensor 160 and the absolute pressure sensor 180. By using the common air passage 152, the sensor 100 ensures that the sensors 160 and 180 reference the same pressure. It will be appreciated, however, that the sensors 160, 180 need not share a common air passage 152, and that the second and fourth air passages 166, 186 can directly exit the wall of the sensor 100 body 110 separately.

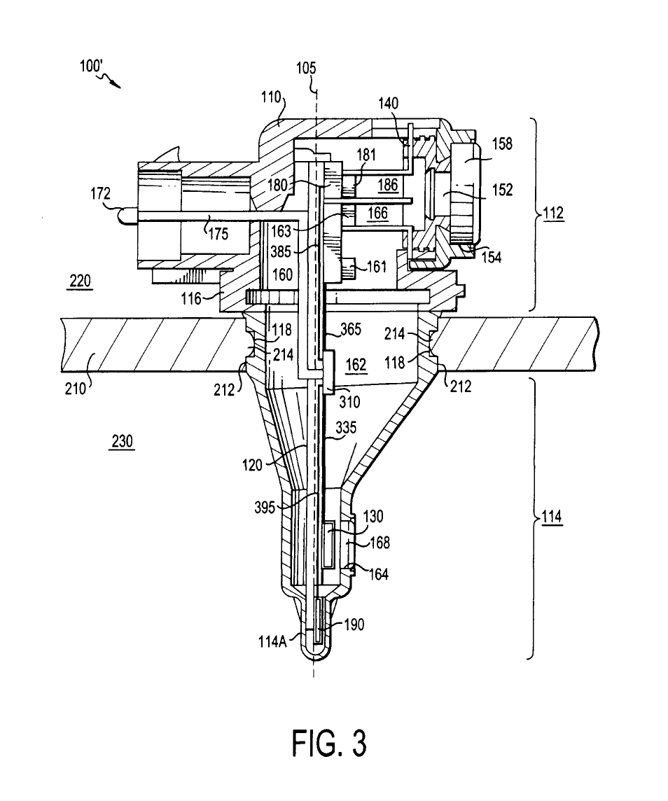

Referring now to FIG. 3, there is illustrated another exemplary embodiment of the sensor 100, generally designated in FIG. 3 as 100′, in accordance with an exemplary embodiment of the present invention. The sensor 100′ comprises all of the components of the sensor 100 but further comprises a microcontroller 310 and signal/communication lines 335, 365, 385, and 395. In an exemplary embodiment, the microcontroller 310 is disposed on the circuit board 120, and the signal/communication lines 335, 365, 385, and 395 are embodied as wire traces on the circuit board 120.

The signal/communication lines 335 electronically connect the temperature and humidity sensor 130 to the microcontroller 310. The signal/communication lines 365 electronically connect the gauge pressure sensor 160 to the microcontroller 310. The signal/communication lines 385 electronically connect the absolute pressure sensor 180 to the microcontroller 310. The signal/communication lines 395 electronically connect the temperature sensor 190 to the microcontroller 310.

The temperature and humidity sensor 130 transmits the measured temperature and humidity of air from the second air space 230 entering the port 164 to the microcontroller 310 via the signal/communication lines 335. The gauge pressure sensor 160 transmits the measured pressure drop across the wall 210 to the microcontroller 310 via the signal/communication lines 365. The absolute pressure sensor 180 transmits the absolute pressure of the first air space 220 entering the port 154 to the microcontroller 310 via the signal/communication lines 385. The temperature sensor 190 transmits the measured ambient temperature within the second air space 230 to the microcontroller 310 via the signal/communications lines 395. The microcontroller 310 forwards received sensor signal values to the electrical connector 172 via the signal/communication lines 175

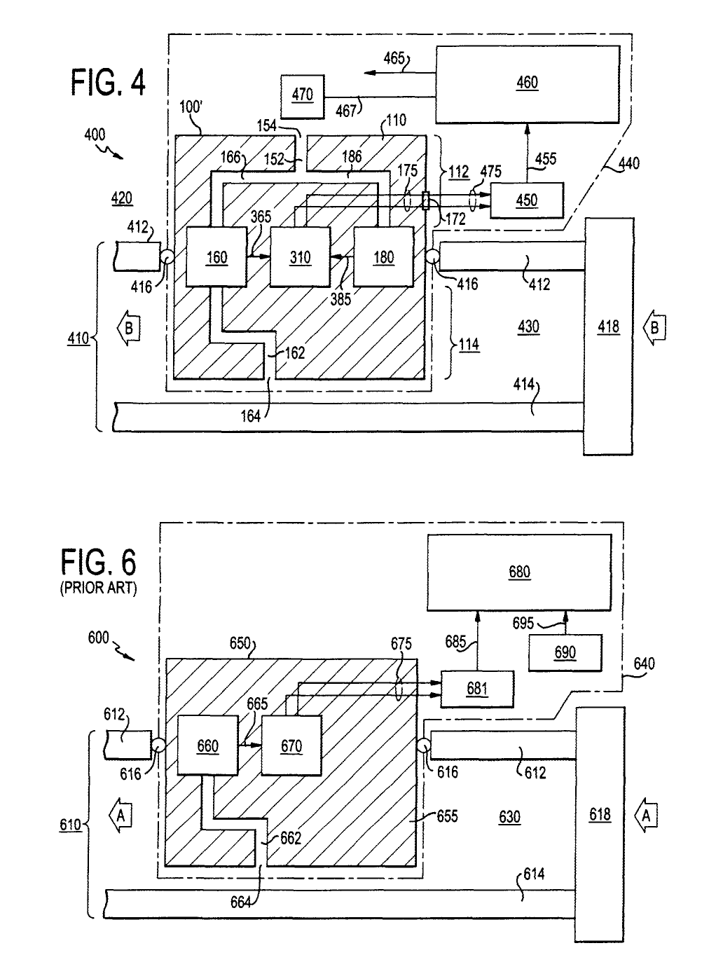

Referring now to FIG. 4, there is there is illustrated a system 400 for sensing a pressure drop (also referred to herein as “differential pressure”) across an air filter 418 in a motor vehicle 410 such as a truck, car, tractor, motorcycle or the like, in accordance with an exemplary embodiment of the present invention. The motor vehicle 410 comprises the air filter 418 and a passageway 430. In one exemplary embodiment, the passageway 430 is an interior cavity (e.g., an interior cavity of an air intake manifold) of an air induction system for an internal combustion engine of the motor vehicle 410. In another exemplary embodiment, the passageway 430 is an inlet into a turbo charger in the motor vehicle 410. For purposes of discussion herein, the passageway 430 is a manifold or the interior cavity of the manifold 430. It is to be understood that the passageway 430 is not limited to being a manifold but may be an inlet to a turbocharger in relevant embodiments of the system 400.

The manifold 430 is formed by two side walls 412 and 414, which as shown can be arranged spaced apart and opposite one another. The air filter 418 extends from one wall 412 to the other wall 414 and is positioned at an intake end of the manifold 430. The air filter 418 filters air passing in a direction B through the filter and the manifold 430 before entering the motor or turbo charger of the motor vehicle 410. The manifold 430 and air filter 418 of the motor vehicle 410 are illustrated in FIG. 4 in cross section.

As the filter 418 becomes dirty, the volume of air passing through the filter 418 drops, thereby reducing performance of the engine of the motor vehicle 410. Accordingly, the system 400 directly senses the drop in air pressure across the filter 418 to determine how dirty the air filter 418 is. To this end, the system 400 further comprises an air pressure sensor system 440 comprising the sensor 100′ for directly sensing the drop in air pressure across the filter 418. The body 110 of the sensor 100′ is mounted in an opening in the wall 412 of the manifold 430 and is sealed by a seal 416, such as a rubber gasket or the like, that is positioned between the sensor body 110 and the wall 412. The sensor 100′ is illustrated in FIG. 4 in simplified block form, in which certain elements, such as the port seal 140, are not illustrated for clarity. It is to be understood that the sensor 100′ comprises the features discussed above with respect to the sensor 100 of FIGS. 1A, 1B, and 2. Further, although the sensor 100′ of FIG. 3 is illustrated as being used in FIG. 4, it is to be understood that the sensor 100 of FIGS. 1-2 or any of its exemplary alternative embodiments discussed above may be used instead. Furthermore, it is to be understood that the sensor 100′ may be used in applications other than that illustrated in FIG. 4, such as in an application for sensing a pressure drop across a wall, such as the wall 210 of FIG. 2.

The sensor system 440 further comprises a communications network 450 and an engine control unit (ECU) 460. The communications network 450 is in communication with the ECU 460 via a signal/communication bus 455. The ECU 460 is mounted in the motor vehicle 410.

The gauge pressure sensor 160 of the sensor 100′ is in air flow communication with the manifold 430 via the first air passage 162 which opens to the manifold 430 via the port 164 in the wall of the sensor body 110. The gauge pressure sensor 160 is also in air flow communication with the surrounding atmosphere 420 via the second air passage 166 and the third air passage 152, which opens to the atmosphere via the port 154 in the wall of the sensor body 110. The top enclosure 112 is located outside the manifold 430 in the atmosphere (ambient air) 420, while the bottom probe body 114 is disposed within the manifold 430.

The gauge pressure sensor 160 directly measures the pressure drop, ΔP₃ (also referred to herein as “differential pressure”), across the filter 418. Specifically, it measures a difference between (1) the pressure in the manifold 430 communicated to the gauge pressure sensor 160 through the first air passage 162 and (2) atmospheric pressure communicated to the gauge pressure sensor 160 through the second and third air passages 166 and 152. The gauge pressure sensor 160 outputs the measured differential pressure value between the pressure in the manifold 430 and atmospheric pressure, which difference is equal to the pressure drop across the air filter 418. The gauge pressure sensor 160 transmits the measured pressure drop across the air filter 120 to the microcontroller 310 via the signal/communication lines 365. The microcontroller 310 forwards the measured differential pressure value to the communications network 450 in the motor vehicle 110 via the signal/communication bus 175, the electrical connector 172, and a signal/communication bus 475. The communication network 450 forwards the measured differential pressure value to the ECU 460 via signal/communication lines 455. The ECU 460 receives the measured differential pressure value.

The absolute pressure sensor 180 communicates with atmosphere 420 via the fourth air passage 186 and the third air passage 152, which opens to the atmosphere 420 via the port 154 in the wall of the sensor body 110. The absolute pressure sensor 180 measures the absolute pressure (also referred to herein as “barometric pressure” or “BP”) of the atmosphere 420 and transmits the measured BP to the microcontroller 310 via the signal/communication lines 385. Because both of the air passages 166 and 186 communicate with atmosphere 420 via the air passage 152, the air passage 152 is a common air passage for both the gauge pressure sensor 160 and the absolute pressure sensor 180. By using the common air passage 154, the air pressure sensor system 440 ensures that the sensors 160 and 180 reference the same atmospheric pressure. It will be appreciated, however, that the sensors 160, 180 need not share a common air passage 152, and that the second and fourth air passages 166, 186 can directly exit the wall separately.

The microcontroller 310 forwards the measured BP value to the communication network 450 via the signal/communication bus 175, the electrical connector 172, and the signal/communication bus 475. The communication network 450 forwards the measured BP value to the ECU 460 via the communications lines 455. The ECU 460 receives the measured BP value and calculates MAP by subtracting the measured pressure drop across the filter 418 (measured by the sensor 160) from the barometric pressure (measured by the sensor 180). In exemplary embodiments in which the motor is a spark displacement engine, the ECU 460 uses the measured BP for spark tolerance. In exemplary embodiments in which the motor is a compression engine, the ECU 460 uses BP for air mass calculation correction.

The range of the gauge pressure sensor 160 is between 0 kPa and 15 kPa. The error rate is 1.5%. 15 kPa represents the maximum pressure drop before the engine of the motor vehicle 410 goes into de-rating for a clogged air filter 418. The range of the absolute pressure sensor 180 is 15 to 120 kPa.

As noted above, the error factor for the sensor 660 in the conventional system 600 is about 2%. That error factor is compounded by the error factor (2%-3%) of the sensor 690, excluding the offset, n, that may be introduced in the cab of the motor vehicle 610. Because the range (0-15 kPa) of the gauge pressure sensor 160 in the system 400 is significantly lower than the range (10-350 kPa) of the sensor 660 in the conventional system 600, the measured differential pressure in the system 400 has lower error than the calculated differential pressure in the conventional system 600. Furthermore, error is introduced in only one place, by the sensor 160, in the system 400 rather than in two places (by the sensor 660 and the sensor 690) in the conventional system 600. The signal-noise-ratio of the differential pressure measured by the sensor 160 is, therefore, greater than that calculated in the conventional system 600. Thus, the system 400 provides for a significantly more accurate measurement of the pressure drop across the filter 418. The measurement of the pressure drop across the air filter 418 by the sensor 160 has an accuracy within +/−0.3 kPa, compared with the error within +/−9.3 kPa for the pressure drop calculated for the air filer 618. Thus, the error in the measured pressure drop across the air filter 418 is reduced from the error of the calculated pressure drop across the filter 618 by over 97%.

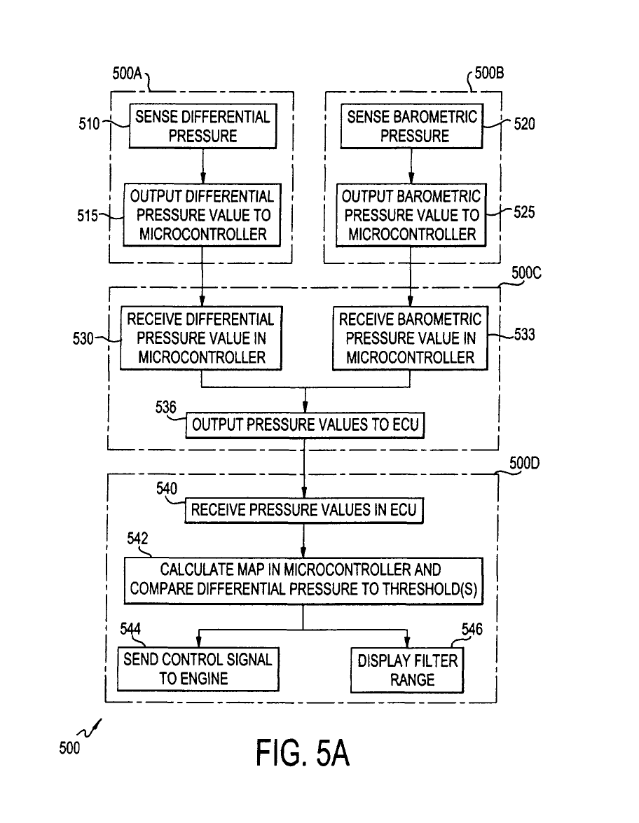

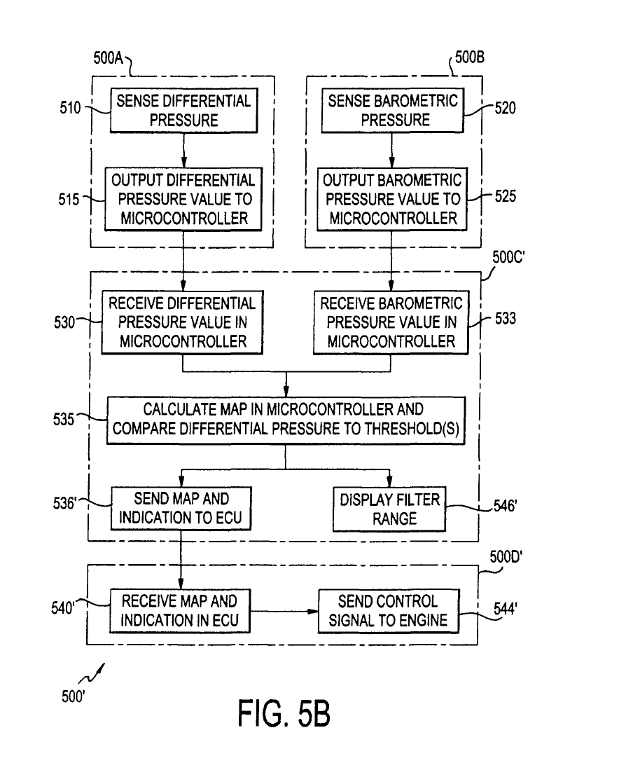

Referring now to FIG. 5A, there is illustrated an exemplary method, generally designated as 500, for measuring the pressure drop across the filter 418 in the system 400, in accordance with an exemplary embodiment of the present invention. The method 500 comprises four sub-routines or sub-methods 500A, 500B, 500C, and 500D. The sub-method 500A comprises Steps 510 and 515 performed by the sensor 160. The sub-method 500B comprises Steps 520 and 525 performed by the sensor 180. The sub-method 500C comprises Steps 530, 533, and 536 performed by the microcontroller 310. The sub-method 500D comprises Steps 540, 542, 544, and 546 performed by the ECU 460.

The sub-methods 500A and 500B may be performed at any time, including at the same time. With reference to sub-method 500A, the gauge pressure sensor 160 senses the pressure drop across the filter 418, Step 510. The gauge pressure sensor 160 outputs the sensed differential pressure value to the microcontroller 310, Step 520. With reference to sub-method 500B, the absolute pressure sensor 180 senses the barometric pressure of the atmosphere 420, Step 520. The absolute pressure sensor 180 outputs the sensed barometric pressure value to the microcontroller 310, Step 525.

With reference to sub-method 500C, the microcontroller 310 receives the measured differential pressure value from the gauge pressure sensor 160, Step 530, and the measured BP value from the absolute pressure sensor 180, Step 533. The microcontroller 310 outputs these values to the ECU 460, Step 536.

With reference to sub-method 500D, the ECU 460 receives the sensed differential pressure value and the sensed barometric pressure value, Step 540. The ECU 460 calculates MAP by subtracting the sensed differential pressure value from the barometric pressure value, Step 542. Based on the calculated MAP value, the ECU 460 provides a control signal to the engine of the motor vehicle 410 via output 465, Step 544. The ECU 460 also provides an indication of how dirty the filter 418 is via an output 467 to a display 470, Step 546.

If the pressure drop, ΔP₃, is below a first threshold amount, the ECU 460 provides an indication to the display 470 that the air filer 418 is clean in the Step 546. If the pressure drop is below a second threshold amount but equal to or greater than the first threshold amount, the ECU 460 provides an indication to the display 470 that the air filter 418 is dirty in the Step 546. If the pressure drop is below a third threshold amount but equal to or greater than the second threshold amount, the ECU 460 provides a control signal to the engine via the output 467 and can take remedial action, such as to lower the power of engine to reduce the amount of air that it consumes in the Step 544 to avoid damaging the engine. If the pressure drop is below a fourth threshold amount but equal to or greater than the third threshold amount, the ECU 460 can take further remedial actions to avoid damaging the engine, such as to provide a control signal to the engine via the output 467 to lower the torque produced by the engine in the Step 544 and provide an indication to the display 470 that the filter 418 must be replaced in the Step 546.

In an exemplary embodiment, the method 500 is performed and repeated on a periodic basis. It is contemplated that the method 500 is repeated every 1 millisecond, for example. In another exemplary embodiment, the microcontroller 310 calculates MAP by subtracting the sensed differential pressure value from the barometric pressure value in the Step 536 and outputs the MAP to the ECU 460 in the Step 536. The ECU 460 receives the MAP in the Step 540. In this embodiment, the Step 542 is omitted.

In another exemplary embodiment, the method 500 is performed with the embodiment of the system 400 using the sensor 100 rather than the sensor 100′. In such embodiment, the sensor 160 outputs the sensed differential pressure value to the ECU 460 in the Step 515, and the sensor 180 outputs the sensed barometric pressure value to the ECU 460 in the Step 525. Processing proceeds from the Steps 515 and 525 to the Step 540. The sub-method 500C is omitted.

Referring now to FIG. 5B, there is illustrated an exemplary alternative embodiment of the method 500, which exemplary alternative embodiment is generally designated as 500′ in FIG. 5B, in accordance with an exemplary embodiment of the present invention. The method 500′ is performed by an exemplary alternative embodiment of the system 400 in which the microcontroller 310 is connected to the display 470 via the signal/communications bus 475.

The method 500′ comprises four sub-routines or sub-methods 500A, 500B, 500C′, and 500D′. The sub-methods 500A and 500B are the same as those of the method 500. The sub-methods 500C′ and 500D′ differ from the sub-methods 500C and 500D of the method 500. The sub-method 500C′ differs from the sub-method 500C in that the sub-method 500C′ includes an additional step 535 and exemplary alternative embodiments of the Step 536 and 546, which exemplary alternative embodiments are designated as 536′ and 546′ in FIG. 5B. The sub-method 500D′ differs from the sub-method 500D in that the sub-method 500D′ omits the Steps 542 and 546 and includes exemplary alternative embodiments of the Steps 540 and 544, which exemplary alternative embodiments are designated as 540′ and 544′ in FIG. 5B.

With respect to the sub-method 500C′, in the Step 535, the microcontroller 310 calculates MAP by subtracting the sensed differential pressure value from the barometric pressure value. The microcontroller 310 compares the sensed differential pressure to the threshold pressure range(s), as done by the ECU 460 in the Step 542. The microcontroller 310 sends the indication (sent in the Step 546 of the method 500) to the ECU 460 in the Step 536′ with the calculated MAP. In the Step 546′, the microcontroller 310 outputs the indication to the display 470, as also done by the ECU 460 in the Step 546.

With respect to the sub-method 500D′, in the Step 540′, the ECU 460 receives the MAP and indication from the microcontroller 310. In the Step 544′, the ECU 460 sends a control signal to the engine based on the indication, as also done by the ECU 460 in the Step 544. Based on the calculated MAP value, the ECU 460 also provides a control signal to the engine of the motor vehicle 410 via the output 465 in the Step 544′.

It is to be understood that the microcontroller 310 can be a processing device, such as a processor, microprocessor, computing device, application specific integrated circuits (ASIC), controller, or the like. The functionality described herein as being performed by the microcontroller 310 can be done by the microcontroller 310 upon loading and executing software code or instructions which are tangibly stored on a computer readable medium, such as on a magnetic medium, e.g., a computer hard drive, an optical medium, e.g., an optical disc, solid-state memory, e.g., flash memory, and other storage media known in the art. Thus, any of the functionality performed by the microcontroller 310 described herein is implemented in software code or instructions which are tangibly stored on a computer readable medium. Upon loading and executing such software code or instructions by the microcontroller 310, the microcontroller 310 may perform any of the functionality of the microcontroller 310 described herein, including any steps of the sub-methods 500C and 500C′ described herein. The microcontroller 310 may be in communication with a computer storage device for storing the pressure values received in the Steps 530 and 533 and/or for storing the MAP calculated in the Step 535. Embodiments in which the microcontroller 310 is an application-specific integrated circuit designed to perform the functionality of the microcontroller 310 described herein are also contemplated.

It is to be understood that the engine control unit 460 can be a processing device, such as a processor, microprocessor, computing device, application specific integrated circuits (ASIC), controller, or the like. The functionality described herein as being performed by the engine control unit 460 can be done by the engine control unit 460 upon loading and executing software code or instructions which are tangibly stored on a computer readable medium, such as on a magnetic medium, e.g., a computer hard drive, an optical medium, e.g., an optical disc, solid-state memory, e.g., flash memory, and other storage media known in the art. Thus, any of the functionality performed by the engine control unit 460 described herein is implemented in software code or instructions which are tangibly stored on a computer readable medium. Upon loading and executing such software code or instructions by the engine control unit 460, the engine control unit 460 may perform any of the functionality of the engine control unit 460 described herein, including any steps of the sub-methods 500D and 500D′ described herein. The engine control unit 460 may be in communication with a computer storage device for storing the pressure values received in the Step 540 and/or for storing the MAP calculated in the Step 542 or received in the Step 540′. Embodiments in which the engine control unit 460 is an application-specific integrated circuit designed to perform the functionality of the engine control unit 460 described herein are also contemplated. In addition, the operation performed by the microcontroller 310 can instead be performed by the ECU 460, such as when the sensor 100 is used in the air pressure sensor system rather than the sensor 100′. In such embodiment, the sensors 160, 180 provide their output directly to the ECU 460 via the signal/communications lines 475, communications network 450 and signal/communications lines 455.

The term “software code” or “code” used herein refers to any instructions or set of instructions that influence the operation of a computer. They may exist in a computer-executable form, such as machine code, which is the set of instructions and data directly executed by a computer's central processing unit, a human-understandable form, such as source code, which may be compiled in order to be executed by a computer, or an intermediate form, such as object code, which is produced by a compiler. As used herein, the term “software code” or “code” also includes any human-understandable computer instructions or set of instructions that may be executed on the fly from a human-understandable form with the aid of an interpreter.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. A sensor comprising:
a sensor body comprising a first air passageway communicating with atmosphere and a second air passageway communicating with an interior cavity of an air induction system for a combustion engine; and
a differential pressure sensor disposed within the sensor body, the differential pressure sensor coupled to the first air passageway connected to the atmosphere and to the second air passageway in communication with the interior cavity of the air induction system, the differential pressure sensor configured to measure a differential pressure between the atmosphere communicated to the differential pressure sensor via the first air passageway and the interior cavity of the air induction system communicated to the differential pressure sensor via the second air passageway.

2. The sensor of claim 1, wherein:
the sensor body further comprises:
a first wall and a first vent disposed in the first wall; and
a second wall and a second vent disposed in the second wall,
the first passageway opens to the atmosphere via the first vent disposed in the first wall of the sensor body, and
the second passageway opens to the interior cavity of the air induction system via the second vent disposed in the second wall of the sensor body.

3. The sensor of claim 2, further comprising:
an absolute pressure sensor disposed with the sensor body,
wherein the sensor body further comprises a third air passageway communicating with the atmosphere,
wherein the absolute pressure sensor is coupled to the third air passageway, and
wherein the absolute pressure sensor is configured to measure an absolute pressure of the atmosphere communicated to the absolute pressure sensor via the third air passageway.

4. The sensor of claim 3, further comprising a controller configured to receive the measured absolute pressure from the absolute pressure sensor.

5. The sensor of claim 2, further comprising:
a common air passageway that opens to the atmosphere via the first vent,
wherein the first air passageway is coupled to the common air passageway and communicates with the atmosphere via the common air passageway, and
wherein the third air passageway is coupled to the common air passageway and communicates with the atmosphere via the common air passageway.

6. The sensor of claim 1, further comprising a controller configured to receive the measured differential pressure from the differential pressure sensor and having an output for transmitting the measured differential to an engine control unit of the motor vehicle via a communications bus.

7. The sensor of claim 1, further comprising a seal configured to isolate the first air passageway from the second air passageway.

8. The sensor of claim 1, further comprising a humidity sensor disposed within the sensor body, wherein the humidity sensor is coupled to the second air passageway in communication with the interior cavity of the air induction system.

9. The sensor of claim 1, further comprising a temperature sensor disposed within the sensor body, wherein the temperature sensor is coupled to the second air passageway in communication with the interior cavity of the air induction system.

10. The sensor of claim 1, further comprising an absolute pressure sensor coupled to the first passageway connected to the atmosphere, the absolute pressure sensor configured to measure a barometric pressure of the atmosphere.

11. The sensor of claim 10, further comprising a microcontroller configured to receive the measured differential pressure from the differential pressure sensor and the barometric pressure from the absolute pressure sensor.

12. The sensor of claim 11, wherein the microcontroller is configured to calculate an absolute pressure in the interior cavity of the air induction system for the combustion engine by subtracting the measured differential pressure from the measured barometric pressure.

13. A sensor system comprising:
a sensor comprising:
a sensor body comprising:
a first air passageway communicating with an atmosphere;
a second air passageway communicating with an interior cavity of an air induction system of a combustion engine;
a differential pressure sensor disposed within the sensor body, the differential pressure sensor coupled to the first air passageway and to the second air passageway, the differential pressure sensor configured to measure a differential pressure between the atmosphere communicated to the differential pressure sensor via the first air passageway and the interior cavity of the air induction system communicated to the differential pressure sensor via the second air passageway; and
a controller configured to receive the measured differential pressure from the differential pressure sensor;
a communications bus; and
an engine control unit of the combustion engine coupled to the communications bus and in communication with the sensor via the communications bus,
wherein the controller further comprises an output for transmitting the measured differential pressure to the engine control unit via the communications bus.

14. The sensor system of claim 13, wherein:
the sensor body further comprises:
a first wall and a first vent disposed in the first wall; and
a second wall and a second vent disposed in the second wall,
the first passageway opens to the atmosphere via the first vent disposed in the first wall of the sensor body, and
the second passageway opens to the interior cavity of the air induction system via the second vent disposed in the second wall of the sensor body.

15. The sensor system of claim 14, wherein:
the sensor further comprises an absolute pressure sensor disposed with the sensor body,
the sensor body further comprises a third air passageway communicating with the atmosphere,
the absolute pressure sensor is coupled to the third air passageway, and
the absolute pressure sensor is configured to measure an absolute pressure of the atmosphere communicated to the absolute pressure sensor via the third air passageway.

16. The sensor system of claim 15, wherein the controller is further configured to receive the measured absolute pressure from the absolute pressure sensor.

17. The sensor system of claim 14, wherein:
the sensor body further comprises a common air passageway that opens to the atmosphere via the first vent,
the first air passageway is coupled to the common air passageway and communicates with the atmosphere via the common air passageway, and
the third air passageway is coupled to the common air passageway and communicates with the atmosphere via the common air passageway.

18. The sensor system of claim 13, wherein the sensor further comprises a seal configured to isolate the first air passageway from the second air passageway.

19. The sensor system of claim 13, wherein the sensor further comprises a humidity sensor disposed within the sensor body, and wherein the humidity sensor is coupled to the second air passageway in communication with the interior cavity of the air induction system.

20. The sensor system of claim 13, wherein the sensor further comprises a temperature sensor disposed within the sensor body, and wherein the temperature sensor is coupled to the second air passageway in communication with the interior cavity of the air induction system.

21. The sensor system of claim 13, wherein the engine control unit is configured to use the measured differential pressure to monitor a pressure loss between a pressure of the atmosphere and a pressure of the interior cavity of the air induction system.

22. The sensor system of claim 21, wherein the engine control unit is configured to use the measured differential pressure to determine a pressure differential across an air filter of the air induction system to ascertain performance and long-term deterioration of the air filter.

23. The sensor system of claim 13, wherein the sensor further comprises an absolute pressure sensor coupled to the first passageway connected to the atmosphere, the absolute pressure sensor configured to measure a barometric pressure of the atmosphere, wherein the output of the controller is further configured for transmitting the measured barometric pressure to the engine control unit via the communications bus.

24. The sensor system of claim 23, wherein the engine control unit is configured to calculate an absolute pressure in the interior cavity of the air induction system for the combustion engine by subtracting the measured differential pressure from the measured barometric pressure.

25. A method for sensing differential pressure comprising steps of:
sensing a differential pressure, using a gauge pressure sensor of a sensor, across an intake filter of an air induction system of a combustion engine, the air induction system comprising an interior cavity, the sensor comprising the gauge pressure sensor and a controller;
outputting the sensed differential pressure value to the controller.

26. The method of claim 25, wherein:
the sensor further comprises a sensor body comprising a first air passageway communicating with atmosphere and a second air passageway communicating with the air induction system of the combustion engine;
the differential pressure sensor is coupled to the first air passageway and to the second air passageway; and
the step of sensing comprises sensing the differential pressure, using the gauge pressure sensor, by sensing a pressure of atmosphere communicated to the differential pressure sensor via the first air passageway and by sensing a pressure of the interior cavity of the air induction system communicated to the differential pressure sensor via the second air passageway.

27. The method of claim 25, further comprising steps of:
sensing a barometric pressure of the atmosphere using an absolute pressure sensor; and
outputting the sensed barometric pressure to the controller,
wherein the vehicle sensor further comprises the absolute pressure sensor.

28. The method of claim 27, wherein:
the sensor body further comprises a third air passageway communicating with the atmosphere; and
the method further comprises a step of sensing the barometric pressure of the atmosphere, using the absolute pressure sensor, by sensing the barometric pressure of the atmosphere communicated to the absolute pressure sensor via the third air passageway.

29. The method of claim 27, wherein:
the sensor is coupled to an engine control unit;
the method further comprises steps of:
outputting the sensed differential pressure and the sensed barometric pressure to the engine control unit;
receiving the sensed differential pressure and the sensed barometric pressure in the engine control unit; and
outputting, by the engine control unit, an indication of whether the intake filter is dirty.

30. The method of claim 27, further comprising a step of calculating a pressure in the interior cavity of the air induction system by subtracting the sensed differential pressure from the sensed barometric pressure.

31. The method of claim 30, wherein the step of calculating is performed by the controller.

32. The method of claim 30, wherein the step of calculating is performed by the engine control unit.
